(19) United States
(12) Patent Application Publication
(10) Pub. No.: US 2024/0161598 A1
(43) Pub. Date: May 16, 2024

(54) PERSONAL SECURITY APPARATUS AND METHOD OF DISSUASION AND PREVENTION

(71) Applicant: Luc Nadier, Lyon (FR)

(72) Inventor: Luc Nadier, Lyon (FR)

(21) Appl. No.: 18/506,748

(22) Filed: Nov. 10, 2023

Related U.S. Application Data
(60) Provisional application No. 63/424,471, filed on Nov. 10, 2022.

(51) Int. Cl. G08B 25/01; G08B 25/00

(52) U.S. Cl. CPC G08B 25/016; G08B 25/003; G08B 25/007

(57) ABSTRACT

A personal security apparatus including an enclosure having enclosure walls for engaging a smartphone, the smartphone having a smartphone camera and smartphone microphone. The personal security apparatus includes a push button disposed on the enclosure wherein the personal security apparatus is activated by a triple pulse on the push button located on a rear panel of the enclosure and wherein the activation of the personal security apparatus includes sounding an alarm provided in the enclosure. The personal security apparatus includes a smartphone application compatible with the smartphone for controlling the personal security apparatus. The smartphone broadcasts live footage of the smartphone camera, microphone and geolocation to emergency contacts. The smartphone application sends an alert to the emergency contacts who can contact police with all necessary information. Recordings collected by the smartphone camera and microphone are available from the smartphone application to file a complaint.

### CROSS-REFERENCE TO RELATED APPLICATIONS

This application is a non-provisional application claiming priority to U.S. provisional patent application Ser. No. 63/424,471, filed on Nov. 10, 2023, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced. The personal security apparatus has been named “Safee” by the applicant of the instant application.

### BACKGROUND OF THE INVENTION

### 1) Field of the Invention

The invention relates to the field of electronic personal security device combined with a safety application intended for consumers.

### 2) Description of Related Art

In today's fast-paced world, personal safety has become a paramount concern. With the rise in crime rates and the increasing number of incidents involving personal harm, there is a growing need for effective measures to ensure personal security. Smartphones, being ubiquitous and always within reach, have been identified as potential tools for enhancing personal safety. However, existing solutions leveraging smartphones for personal safety are often complex, requiring multiple steps to activate, which may not be feasible in a situation of distress. Furthermore, these solutions often fail to provide comprehensive information that could aid in the identification and apprehension of the perpetrator. Therefore, there is a need for a more effective, user-friendly, and comprehensive personal safety solution.

The problem that is solved is a device that allows to secure and reduce the insecurity present in the streets as well as in the personal sphere through a new technology that allows a person to Deter/Prevent/Support self or victim of any type of aggression.

The personal security apparatus solve three different problems:
1—More than 380 million people fear for their lives on the streets between the US and Europe. The personal security apparatus aims to solve this problem with its new deterrent technology
2—More than one-third of women in the U.S. (35.6% or approximately 42.4 million) have been raped, physically abused or stalked by their partner at some point in their lives. The personal security apparatus aims to address this problem through discreet mode.
3—Many people do not file complaints due to lack of evidence; The personal security apparatus aims to solve this problem through the recording and redirection of evidence.

### SUMMARY OF THE INVENTION

In accordance with embodiments, a security apparatus is provided, comprising one or more protective casings for accommodating a mobile device, one or more activation mechanisms disposed on the protective casing, and one or more software compatible with the mobile device for managing the security apparatus. The security apparatus is engaged by a triple pulse on the activation mechanism located on the back of the casing, which includes emitting an alert provided in the protective casing.

In accordance with other embodiments, a method of providing personal security is provided. The method includes engaging a security apparatus by a triple pulse on an activation mechanism located on the back of a protective casing, emitting an alert provided in the protective casing upon engagement of the security apparatus, and managing the security apparatus using one or more software compatible with a mobile device accommodated in the protective casing. The method also includes transmitting real-time visuals of an imaging device, audio of an audio capture device and location data of a location tracking system to a plurality of designated contacts using the mobile device, dispatching a notification to the designated contacts using a mobile application, and making the captured data collected by the imaging device and audio capture device accessible from the mobile application for report submission.

Bearing in mind the problems and deficiencies of the prior art, it is therefore an object of the present invention to provide a personal security apparatus which provides a safety alarm for deterring a possible assailant.

It is another object of the present invention to provide a personal security apparatus having the ability to track events for use in a complaint or search.

The above and other objects, which will be apparent to those skilled in the art, are achieved in the present invention which is directed to a personal security apparatus including an enclosure having enclosure walls for engaging a smartphone, the smartphone having a smartphone camera and smartphone microphone. The personal security apparatus includes a push button disposed on the enclosure wherein the personal security apparatus is activated by a triple pulse on the push button located on a rear panel of the enclosure and wherein the activation of the personal security apparatus includes sounding an alarm provided in the enclosure. The personal security apparatus includes a smartphone application compatible with the smartphone for controlling the personal security apparatus. The smartphone broadcasts live footage of the smartphone camera, microphone and geolocation to emergency contacts. The smartphone application sends an alert to the emergency contacts who can contact police with all necessary information. Recordings collected by the smartphone camera and microphone are available from the smartphone application to file a complaint. The activation of the personal security apparatus may include activating a light within the enclosure. The smartphone application may include a discreet mode wherein the alarm is silent when the smartphone application is activated in the discreet mode. The personal security apparatus may include a discreet mode for broadcasting live footage, geolocation and a microphone recording to the emergency contacts of a user. The personal security apparatus may include a journey feature wherein a user activates the journey feature upon beginning a journey and wherein emergency contacts are allowed to follow progress of the journey in real time and have access to previous recordings of the journey. The personal security apparatus application may allow a user to see partner stores on a route where the user can take refuge in case of attempted attacks. The personal security apparatus may include a smartphone application which sends a notification to nearby application users and partner stores warning of a potential danger. The personal security apparatus may include an unlock alarm feature wherein an accidental activation may be deactivated using a user password. The sound pressure from the alarm is preferably at least 120 decibels and more preferably at least 130 decibels. The alarm and the broadcast from the smartphone may be individually activated.

Another aspect of the present invention is directed to a method for using the personal security apparatus. The method includes a user activating the personal security apparatus a triple push on the push button; the alarm sounding; the smartphone commencing broadcasting live camera and microphone footage to emergency contacts and the smartphone sending an alert to the emergency contacts with information regarding the alert. The method may include the user accessing recorded information for filing a complaint.

Another aspect of the present invention is directed to a personal security phone case module including a module enclosure for engaging a smartphone case wherein the smartphone case holds a smartphone having a smartphone camera, a smartphone light and a smartphone microphone. The personal security phone case module includes a push button disposed on the smartphone enclosure wherein the personal security phone case module is activated by a triple pulse on the push button located on a rear panel of the smartphone enclosure and wherein activation of the personal security phone case includes sounding an alarm provided in the smartphone enclosure. The personal security phone case module includes a smartphone application compatible with the smartphone for controlling the personal security phone case module. The smartphone may broadcasts live footage of the smartphone camera, microphone and geolocation to emergency contacts. The smartphone application may send an alert to the emergency contacts who can contact police with all necessary information. Recordings collected by the smartphone camera and smartphone microphone are available from the smartphone application to file a complaint. The smartphone application may include a discreet mode wherein the alarm and the smartphone light are turned off when the smartphone application is activated in the discreet mode. The personal security phone case may include a discreet mode for broadcasting live footage, geolocation and microphone recording discreetly to a user's emergency contacts. The smartphone application may include a journey feature wherein before making a trip, a user can activate the journey feature, which allows emergency contacts to follow progress of the trip in real time. The application may allow a user to see partner stores on a route where the user can take refuge in case of attempted attacks. The smartphone application may send a notification to nearby application users and partner stores warning of a potential danger from a person nearby so that they can act. The personal security phone case may include an unlock alarm feature wherein an accidental activation may be deactivated using a user password. The alarm may be at least 120 decibels and preferably at least 130 decibels.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a rear perspective view of the personal security apparatus according to the present invention;

FIG. 2 is a rear perspective view of the personal security module provided in the personal security apparatus;

FIG. 3 is a rear view of the personal security module shown in FIG. 2;

FIG. 4 is a rear elevational view of the personal security apparatus shown in FIG. 1;

FIG. 5 is a side elevational view of the personal security apparatus shown in FIG. 1

FIG. 6 shows a pictorial of a method of using the personal security apparatus shown in FIG. 1;

FIG. 7 shows a screen shot of the application features provided for the personal security apparatus;

FIG. 8 shows a screen shot of the application features provided for the personal security apparatus;

FIG. 9 shows a screen shot of the application features provided for the personal security apparatus;

FIG. 10 shows a screen shot of the application features provided for the personal security apparatus;

FIG. 11 shows a flowchart for the implementation of the personal security apparatus and corresponding application;

FIG. 12 shows a flowchart for the implementation of the personal security apparatus and corresponding application;

FIG. 13 is a schematic diagram showing the components used for the present invention;

FIG. 14 is a list itemizing the electrical components used for the present invention; and

FIG. 15 is a layout diagram showing the major components used for the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The present invention relates to a personal security apparatus linkable to an application that accompanies a user in the streets, at work or at home to ensure personal user safety. The personal security apparatus case is activated by a triple pulse on the push button located on the back of the case. Once the device is activated by pushing the button three times consecutively, a 130 decibels alarm or similar is sounded from the case. The phone secured within the case broadcasts live cameras, microphone and geolocation to emergency contacts. The mobile application sends an alert to the contacts who can contact the police with all the necessary information wherein all the recordings collected are available for consultation from the application to file a complaint. From the application, the user can access all recordings of the user and all the records of the user for filing a complaint directly from the application.

A discreet mode works operates the signaling or transmitting feature without alarm or phone flash. In the discreet mode, a user is able to broadcast live cameras, geolocation and microphone recording discreetly to a user's emergency contacts. The user activates the discreet mode from the application, and activates the personal security apparatus case whenever inappropriate actions occur or the user fears there may be danger.

Recordings are saved short term but may be moved to other locations for longer storage and use. A journey feature, in addition to the emergency system, with the trip tracker, a user can feel safe on a user's daily commute at any time of the day or night! Before making a trip, a user can activate the trip tracker, which allows emergency contacts to follow the progress of the trip in real time. A user will no longer be afraid on a user's daily trips! This feature also allows a user to see the partner stores on a user's route where a user can take refuge in case of attempted attacks.

A help feature application sends a notification to nearby application users and partner stores warning of a potential danger from a person nearby so that they can act.

In the event of accidental activation, the alarm can be deactivated using the user's secret code.

Unique features: the fact of integrating an entire electronic system in a phone case that allows a reactivity by activating in less than a second the entire system without the phone being thick or heavy. The use of an alarm 110 to 130 decibels to dissuade aggression. Live transmission of cameras, microphones and geolocation to emergency contacts. The system is totally imperceptible and can be worn at all times without adding an “accessory” or object to a user daily life

The personal security apparatus offers an anti-aggression solution that is not based solely on prevention. The personal security apparatus offer a security assistance system before, during and after the aggression (Tracking, Aggression function, Legal evidence).

The personal security apparatus a system allows a user to be protected in the street as well as at home or at work, our system adapts to all situations.

The personal security apparatus uses an object that we already wear every day: a phone case

The personal security apparatus is a phone case aligned with the price of the most famous phone cases

The personal security apparatus protects from shocks and is 100% recyclable

The personal security apparatus is not thicker and does not weigh more than a “classic” phone case.

The personal security apparatus is totally imperceptible

It achieves its 3 objectives through the different features: Deterrence, Alarm at 130 decibels and Phone flash

Prevention: Live transmission of camera, microphone, geolocation to emergency contacts, 130 decibel alarm (to warn surrounding people), tracking functionality for a better reactivity, shelter functionality in partner stores

Support: Provision of legal evidence to be able to file a complaint on all devices of the emergency contacts and the assaulted person.

Main objectives: The personal security apparatus aims to secure and reduce the insecurity present in the streets of urban environments as well as in the personal sphere through a new technology that will accompany a user in the streets, at work as well as at home (a phone case connected with an application). The personal security apparatus allows to deter the aggressor and to legally pursue any wrongdoing.

The main objective of the personal security apparatus is to deter all types of aggressions by means of the surprise effect and panic, to warn of the danger in progress to the emergency contacts or people in the vicinity, to accompany the victims of aggression by providing them with recordings so that they can file a complaint with tangible evidence.

The invention integrates an entire electronic system in a phone case that allows a reactivity by activating in less than a second the entire system without the phone being thick or heavy. The use of an alarm to dissuade aggression. Live transmission of cameras, microphones and geolocation to emergency contacts. The system is totally imperceptible and can be worn at all times without adding an “accessory” or object to a user daily life.

The personal security apparatus offers technology (a phone case with an integrated electronic system) linked to an application that will accompany a user in the streets, at work or at home to ensure a user's safety! The following explanation only explains the basic operation without the added features.

The personal security apparatus case is activated by a triple pulse on the push button located on the back of the case. A 130 decibels alarm inside the case is activated. 3—A user's phone broadcasts live cameras, microphone and geolocation to emergency contacts. The application sends an alert to the contacts who can contact the police with all the necessary information. All the recordings collected are available for consultation from the application to file a complaint. The discreet mode works the same way without alarm or phone flash. The discreet mode works the same way without alarm or phone flash. Several functionalities in the application are added to the general functioning of the system:
Legal Feature: From the application, a user can consult all user's records so that a user can file a complaint directly.
Discreet Feature: Thanks to the discreet mode feature, a user will be able to broadcast live cameras, geolocation and microphone recording discreetly to a user's emergency contacts. Simply activate the discreet mode from the app, and activate the personal security apparatus case whenever inappropriate actions occur in any type of location.
Journey feature: In addition to the emergency system, with the trip tracker, a user can feel safe on a user's daily commute at any time of the day or night! Before making a trip, a user can activate the trip tracker, which allows emergency contacts to follow the progress of the trip in real time. A user will no longer be afraid on a user's daily trips. This feature also allows a user to see the partner stores on a user's route where a user can take refuge in case of attempted attacks. The application sends a notification to nearby application users and partner stores warning of a potential danger from a person nearby so that they can act.
Unlock alarm feature: In the event of accidental activation, the alarm can be deactivated using the user's secret code.

The invention alerts other people about an emergency situation. Other people are alerted through a loud alarm integrated in the application when someone close to them is in danger. Emergency contacts need to download the application to get the loud alerts+live camera, microphone and geolocation tracking. Directly from the application the emergency contacts can warn the police by calling them, so they will have all the necessary information (aggressor, clothing colors, locations, level of danger of the situation etc. . . . )

An alert to other users of the invention is triggered wherein an alert to other users through the application that sends signals to the application of emergency contacts or partner stores. All communication is done through the internet and the application. For integration with a cell phone, the phone shell is not very thick (between 1 mm and 1.5 mm) which does not make it thicker than the normal one and is not heavier than the normal one which allows the shell to integrate perfectly with the cell phone since it acts like a normal shell. The shell separates the electronic components of the phone by a layer of plastic that allows to protect the electronic elements.

Installing the app includes:
1. Going in the App Store
2. Downloading the app
3. Going in the App
4. Connecting a user's phone case to the app (If a user does not have the phone case the user can stay on the Free part who is more here for be an emergency contact)
5. Performing a test for be sure everything is working
6. Choosing password, accept terms and conditions.
7. User is protected by The personal security apparatus, the application and his phone case.

Technical Side: When the user presses the button on the case:
1. The microcontroller receives the signals from the button
2. The microcontroller sends a signal to the alarm (if alarm mode) with a frequency to make it ring.
3. In parallel, the microcontroller activates the Bluetooth module to send a signal to the phone to start the application. The microcontroller is powered continuously. The microcontroller is in sleep mode but is activated as soon as the push button is pressed in order to detect if other presses are made.

When the Bluetooth module is in sleep mode, the module keeps the connection with the phone and switches to standard mode only when it needs to communicate with the phone (sleep mode saves battery power). The battery is recharged from a usb-c plug. The microcontroller performs periodic checks of the battery level to alert the user if he needs to recharge the case.

The phone case is composed of a button located on the back of the shell to trigger the emergency process, a PCB with microcontroller, an alarm, a battery and a usb-c plug.

In an alternate embodiment of the present invention, the phone case uses a phone chip to communicate directly without going through the application. The phone case uses an internet connection chip to connect directly to the internet without going through the application. The phone case uses an NFC connection instead of Bluetooth to transmit information to the application. The phone case uses smaller and thinner printed circuit boards like in an NFC module and a battery recharge by Rx coil and not by recharge wire. The phone case uses a hidden push button on the back or any side. Small objects that would be electronically composed in the same way but that would not be phone covers but rather small magnetic boxes that would allow to stick on all phones, or connected bracelets, connected necklaces, boxes to attach on clothes.

The present invention also includes a more resistant phone cover with a similar electronic system, except that the connection is not done by internet but by means of chips that would pass through the cellular network. It would be aimed at a sporting target that needs to protect itself from all possible accidents (Skiing, Hiking, bivouac etc. . . . )

The present invention relates to a device (anti-aggression phone shell) to allow any member of the population to have close security for the purpose of dissuasive against attacks, (to be specified).

Traditionally, when a person is attacked, they must contact the police and avoid any potentially violent encounter. The reality is that today many people get firearms.

Defenses exist such as pepper spray, tear gas or tasers. Assaults take place with impunity, without ever having any means of finding or bringing to justice the aggressor.

Many of these weapons are illegal, they can quickly turn against the victim, which risks creates situations of complicated intervention, collection of complicated evidence as well as people morally and psychologically affected in the medium, long term.

The security device according to the invention makes it possible to remedy this inconvenience. It includes according to a first characteristic, an electronic system embedded in the phone shell by which all the characteristics of alarms and interconnectivity with the application. It includes an alarm, a push button and Bluetooth module.

According to particular embodiments the push button allows the activation of the shell of anti-aggression phone, the alarm activates a shrill noise of 105 Decibels and the Bluetooth module allows interconnectivity with the app.

The device comprises a battery, managed by the battery management module and rechargeable by the Rx coil. As soon as the triple push is detected on the push button 20, the microcontroller is activated which activates the piezoelectric buzzer or other loud alarm. By sending the microcontroller a signal, simultaneously the microcontroller, deactivates the “sleep mode”, by sending the data to the phone for application launch, to the Bluetooth module for interaction with application. The purpose of the activation button 20 is to launch the deterrent system by a triple pressure. The cameras front and back cameras light up and record for forensic evidence as well as analysis of the situation by artificial intelligence, Either before or after, an alarm of 105 decibels or more is triggered (5 seconds of alarm, 3 seconds of pause, this feature allows a user to deactivate the alarm in the event of an activation error through voice recognition). The microphone of the smartphone records during the lapses of time of non-alarm of 3 seconds for legal evidence as well as analysis of the situation by intelligence artificial. The communication of the information collected during the attack will be sent to the emergency contacts following the consent of the user. A message is displayed on the smartphone to warn that the police are on the way with an average response time. All information from the user is available directly from the blocking screen, in the event of intervention by the police forces or firefighters.

The application will be in direct interconnectivity with the hull to allow geolocation, data collection (video+audio), the biometric identification of the owner, the communication with close people facilitating communication with law enforcement.

By way of non-limiting example, the box will have inside dimensions sufficient to secure a smartphone and may vary depending on the model of smartphone used therewith.

The device according to the invention is particularly intended for the personal safety of the persons concerned.

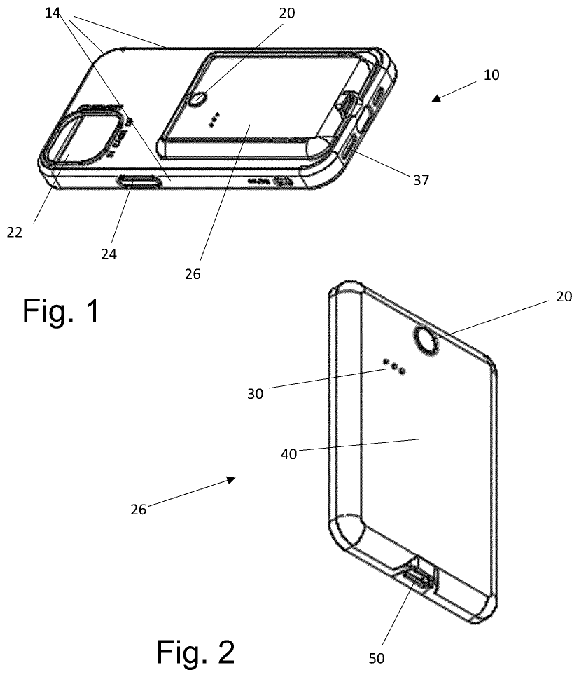

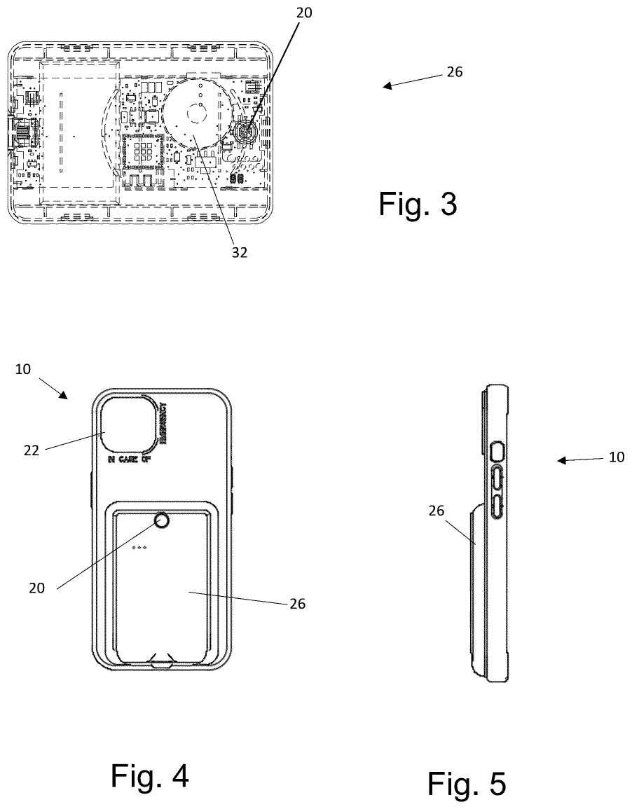

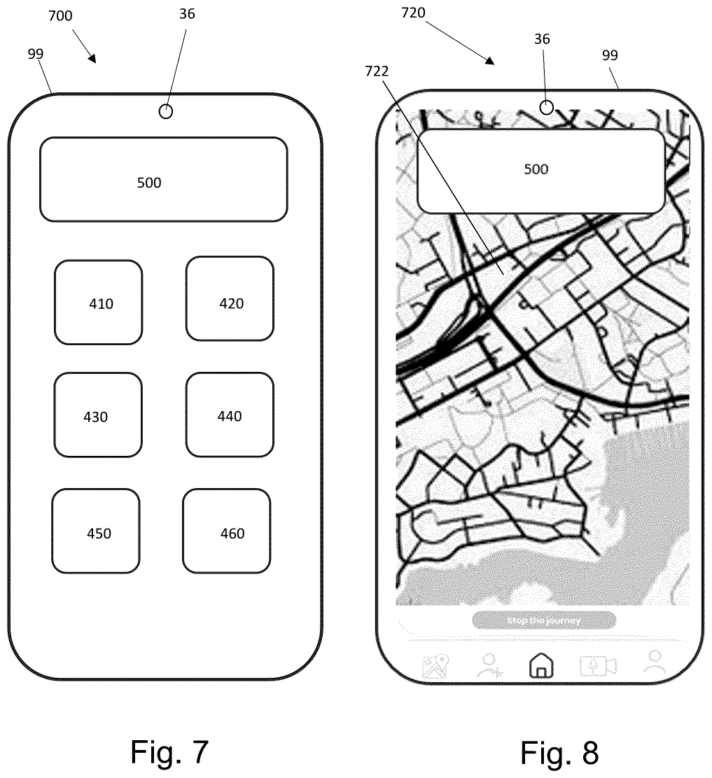

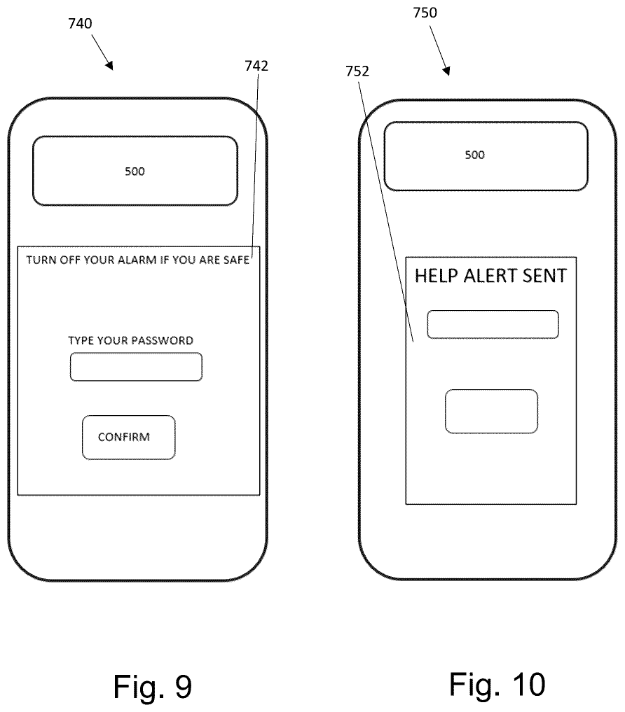

With reference to FIG. 1-12, and more particularly to FIG. 1, a personal security apparatus 10 includes an enclosure 12 having enclosure walls 14 for engaging a smartphone 99, the smartphone 99 having a smartphone camera 36 and smartphone microphone 37. The personal security apparatus includes a push button 20 disposed on the enclosure wherein the personal security apparatus is activated by a triple pulse on the push button 20 located on a rear panel of the enclosure and wherein the activation of the personal security apparatus includes sounding an alarm provided in the enclosure. The alarm 32 shown in FIG. 3 provides sound which at least partially goes through the sound opening 30 on the enclosure 12. The personal security apparatus 10 includes a smartphone application compatible with the smartphone 99 for controlling the personal security apparatus 10. The smartphone 99 broadcasts live footage of the smartphone camera 36, microphone 37 and geolocation to emergency contacts. The smartphone application sends an alert to the emergency contacts who can contact police with all necessary information. Recordings collected by the smartphone camera 36 and microphone 37 are available from the smartphone application to file a complaint. The activation of the personal security apparatus 10 may include activating a light within the enclosure. The smartphone application may include a discreet mode wherein the alarm is silent when the smartphone application is activated in the discreet mode. The personal security apparatus 10 may include a discreet mode for broadcasting live footage, geolocation and a microphone recording to the emergency contacts of a user. The personal security apparatus 10 may include a journey feature wherein a user activates the journey feature upon beginning a journey and wherein emergency contacts are allowed to follow progress of the journey in real time and have access to previous recordings of the journey. As shown in the smartphone screen 700 of FIG. 7, the personal security apparatus application includes an application name 500 and allows a user to see partner stores 410, 420, 430, 440, 450 and 460 on a route 722 shown on the smartphone screen 720 where the user can take refuge in case of attempted attacks. The personal security apparatus 10 may include a smartphone application which sends a notification to nearby application users and partner stores warning of a potential danger. As shown on the smartphone screen 740 in FIG. 9, the personal security apparatus may include an unlock alarm feature 742 wherein an accidental activation may be deactivated using a user password. The sound pressure from the alarm is preferably at least 120 decibels and more preferably at least 130 decibels. The alarm and the broadcast from the smartphone may be individually activated wherein the broadcast may be initiated without setting off the alarm in cases where a user may be nervous enough to have an emergency contact available if needed, but not completely confident that an approaching person has bad intentions. FIG. 10 shows a screen shot wherein the smartphone screen includes a confirmation that an alert has been sent. The screen may include additional information such as confirmation that an emergency contact has seen the alert.

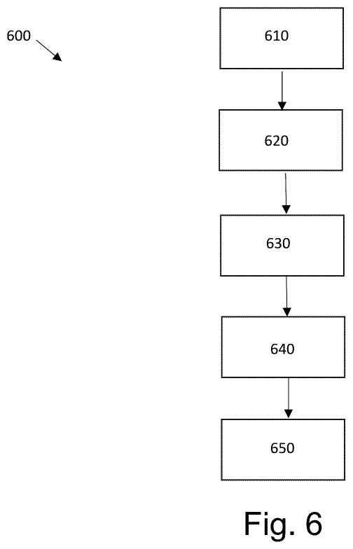

Another aspect of the present invention is directed to a method for using the personal security apparatus as shown in flowchart 600 in FIG. 6. The method includes a user activating the personal security apparatus using a triple push on the push button 610 and the alarm sounding 620. The method includes the smartphone commencing broadcasting live camera and microphone footage to emergency contacts 630 and the smartphone sending an alert to the emergency contacts with information regarding the alert 640. The method may include the user accessing recorded information for filing a complaint 650.

Another aspect of the present invention is directed to a personal security phone case module 26 as shown in FIGS. 2 and 3 of the drawings. The personal security phone case module 26 includes a module enclosure 40 for engaging a smartphone case wherein the smartphone case holds a smartphone 99 having a smartphone camera 36, a smartphone light and a smartphone microphone 37. The personal security phone case module 26 includes a push button 20 disposed on the module enclosure 40 wherein the personal security phone case module is activated by a triple pulse on the push button located on a rear panel of the smartphone enclosure and wherein activation of the personal security phone case includes sounding an alarm provided in the smartphone enclosure. The personal security phone case module includes a smartphone application compatible with the smartphone for controlling the personal security phone case module. The smartphone may broadcasts live footage of the smartphone camera, microphone and geolocation to emergency contacts. The smartphone application may send an alert to the emergency contacts who can contact police with all necessary information. Recordings collected by the smartphone camera and smartphone microphone are available from the smartphone application to file a complaint. The smartphone application may include a discreet mode wherein the alarm and the smartphone light are turned off when the smartphone application is activated in the discreet mode. The personal security phone case may include a discreet mode for broadcasting live footage, geolocation and microphone recording discreetly to a user's emergency contacts. The smartphone application may include a journey feature wherein before making a trip, a user can activate the journey feature, which allows emergency contacts to follow progress of the trip in real time. The application may allow a user to see partner stores on a route where the user can take refuge in case of attempted attacks. The smartphone application may send a notification to nearby application users and partner stores warning of a potential danger from a person nearby so that they can act. The personal security phone case may include an unlock alarm feature wherein an accidental activation may be deactivated using a user password. The alarm may be at least 120 decibels and preferably at least 130 decibels.

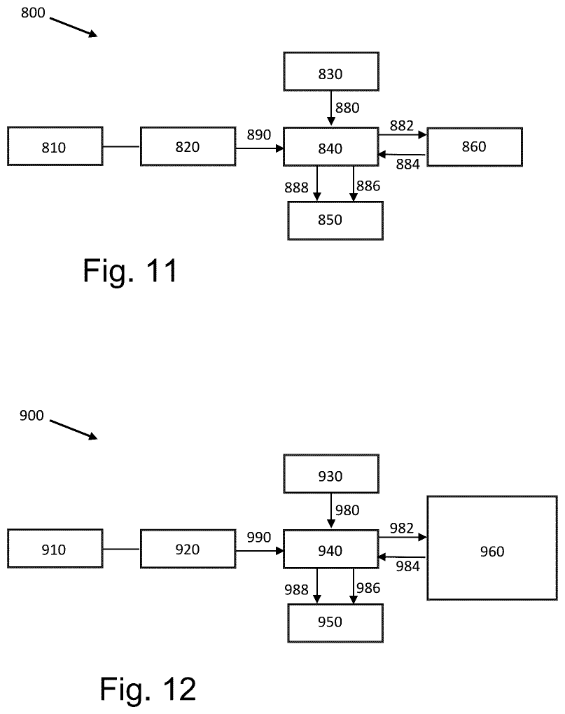

FIG. 11 shows a block diagram 800 of the personal security apparatus. The battery 810 powers the case 820 where a battery level signal 890 may be sent to the circuit board 840. The circuit board 840 includes the primary controller and is in electrical communication 880 with a switch or press button 830. The phone application 860 receives the activation signal 884 and also receives an alert 882 if the battery level is below 20 percent. The alarm 850 is activated by 3 presses 888 of the push button 830 and may be switched off 886 by a deactivation feature.

FIG. 12 shows a block diagram 900 of the personal security apparatus. The battery 910 powers the case 920 where a battery level signal 990 may be sent to the circuit board 940. The circuit board 940 includes the primary controller and is in electrical communication 980 with a switch or press button 930. The phone application 960 receives the activation signal or an alert 982 if the battery level is below 20 percent. The alarm 950 is activated by 3 presses 988 of the push button 930 and may be switched off 986 by a deactivation feature. A signal 984 from the application 960 may deactivate the alarm or put the circuit in silence mode. The application 960 may communicate to the circuit board 940 by Bluetooth or other wireless format.

Another embodiment of the present invention includes a security device allowing all members of the population to have close security as a deterrent against attacks by means of a hull of phone. Characterized in that it includes a push button which activates the battery management, it sends a signal to the microcontroller which activates the alarm simultaneously the Bluetooth module active to create interconnectivity to the application.

The push button may constitute a part of the anti-aggression telephone shell, which activates the microcontroller by means of power supply from the battery. The battery may activate the alarm and the Bluetooth module simultaneously. The recording camera which influences the microphone recording through a pause every 5 seconds, may include a deactivation occurring after 3 seconds.

The invention relates to an integrated electronic device, an anti-aggression phone case to secure all members of the population to have close security as a deterrent against attacks and others. The device comprises a push button which activates the battery, it sends a signal to the microcontroller which activates the alarm simultaneously the Bluetooth module activates to create interconnectivity to the application. The device according to the invention is particularly intended for personal safety in all situations. The phone case is composed of a button located on the back of the shell to trigger the emergency process, a PCB with microcontroller, an alarm, a battery and a usb-c plug.

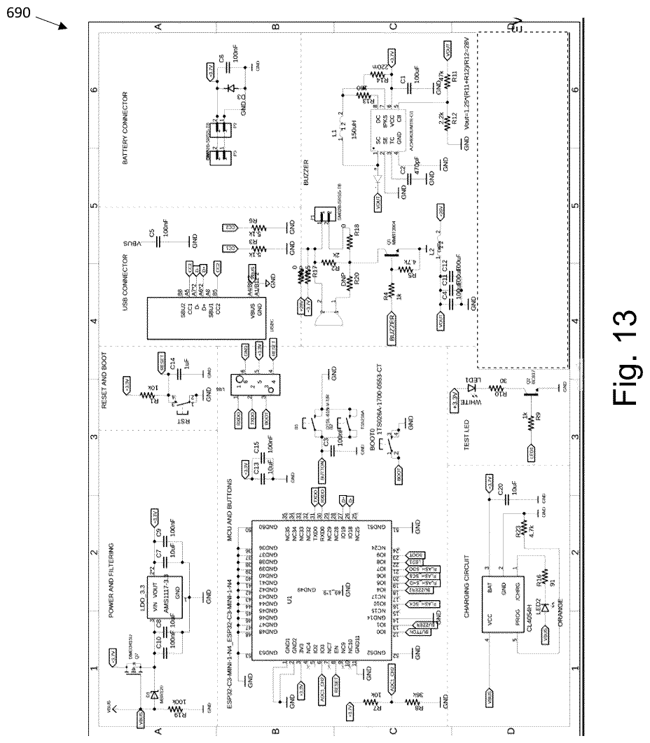

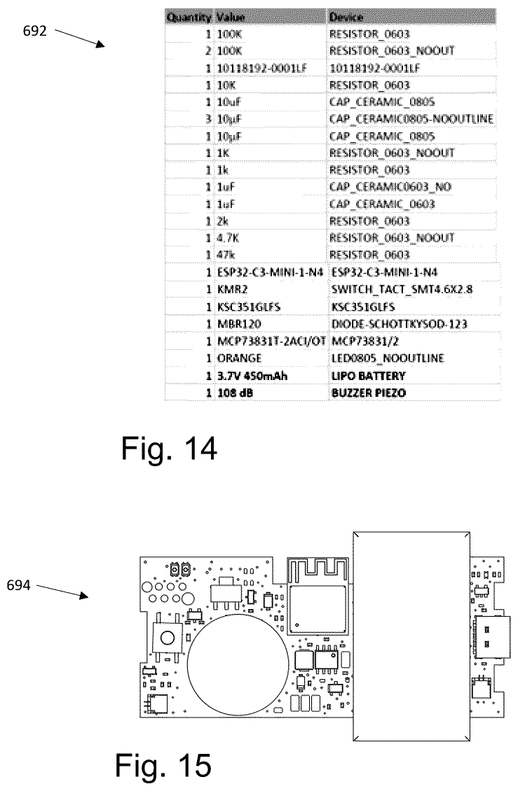

FIG. 13 is a schematic diagram showing the circuit used in the implementation of the security device while FIG. 14 is a list itemizing the electrical components used in the electrical circuit. FIG. 15 shows a circuit board showing the component layout.

In some embodiments the method or methods described above may be executed or carried out by a computing system including a tangible computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A personal security apparatus comprising:
an enclosure including enclosure walls for engaging a smartphone, the smartphone having a smartphone camera and smartphone microphone;
a push button disposed on the enclosure wherein the personal security apparatus is activated by a triple pulse on the push button located on a rear panel of the enclosure and wherein the activation of the personal security apparatus includes sounding an alarm provided in the enclosure; and
a smartphone application compatible with the smartphone for controlling the personal security apparatus;
wherein the smartphone broadcasts live footage of the smartphone camera, microphone and geolocation to emergency contacts;
wherein the smartphone application sends an alert to the emergency contacts who can contact police with all necessary information; and
wherein recordings collected by the smartphone camera and microphone are available from the smartphone application to file a complaint.

2. The personal security apparatus according to claim 1 wherein the activation of the personal security apparatus includes activating a light within in the enclosure.

3. The personal security apparatus according to claim 1 wherein the smartphone application includes a discreet mode wherein the alarm is silent when the smartphone application is activated in the discreet mode.

4. The personal security apparatus according to claim 1 including a discreet mode for broadcasting live footage, geolocation and a microphone recording to the emergency contacts of a user.

5. The personal security apparatus according to claim 1 including a journey feature wherein a user activates the journey feature upon beginning a journey and wherein emergency contacts are allowed to follow progress of the journey in real time and have access to previous recordings of the journey.

6. The personal security apparatus according to claim 5 wherein the journey feature allows a user to see partner stores on a route where the user can take refuge in case of attempted attacks.

7. The personal security apparatus according to claim 1 wherein the smartphone application sends a notification to nearby application users and partner stores warning of a potential danger.

8. The personal security apparatus according to claim 1 including an unlock alarm feature wherein an accidental activation may be deactivated using a user password.

9. The personal security apparatus according to claim 1 wherein sound pressure from the alarm is preferably at least 120 decibels and more preferably at least 130 decibels.

10. The personal security apparatus according to claim 1 wherein the alarm and the broadcast from the smartphone are individually activated.

11. A method for using the personal security apparatus according to claim 1, the method comprising:
a user activating the personal security apparatus using a triple push on the push button;
the alarm sounding;
the smartphone commencing broadcasting live camera and microphone footage to emergency contacts; and
the smartphone sending an alert to the emergency contacts with information regarding the alert.

12. The method according to claim 11 including the user accessing recorded information for filing a complaint.

13. A personal security phone case module comprising:
a module enclosure for engaging a smartphone case wherein the smartphone case holds a smartphone having a smartphone camera, a smartphone light and a smartphone microphone;
a push button disposed on the module enclosure wherein the personal security phone case module is activated by a triple pulse on the push button located on a rear panel of the smartphone enclosure and wherein activation of the personal security phone case includes sounding an alarm provided in the smartphone enclosure; and
a smartphone application compatible with the smartphone for controlling the personal security phone case module;
wherein the smartphone broadcasts live footage of the smartphone camera, microphone and geolocation to emergency contacts;
wherein the smartphone application sends an alert to the emergency contacts who can contact police with all necessary information; and
wherein recordings collected by the smartphone camera and smartphone microphone are available from the smartphone application to file a complaint.

14. The personal security phone case according to claim 13 wherein the smartphone application includes a discreet mode wherein the alarm and the smartphone light are turned off when the smartphone application is activated in the discreet mode.

15. The personal security phone case according to claim 13 including a discreet mode for broadcasting live footage, geolocation and microphone recording discreetly to a user's emergency contacts.

16. The personal security phone case according to claim 13 including a journey feature wherein before making a trip, a user can activate the journey feature, which allows emergency contacts to follow progress of the trip in real time.

17. The personal security phone case according to claim 13 wherein the application allows a user to see partner stores on a route where the user can take refuge in case of attempted attacks.

18. The personal security phone case according to claim 13 wherein the smartphone application sends a notification to nearby application users and partner stores warning of a potential danger from a person nearby so that they can act.

19. The personal security phone case according to claim 13 including an unlock alarm feature wherein an accidental activation may be deactivated using a user password.

20. The personal security phone case according to claim 13 wherein the alarm is at least 120 decibels and preferably at least 130 decibels.
